(19) United States
(12) Patent Application Publication
(10) Pub. No.: US 2016/0283958 A1
(43) Pub. Date: Sep. 29, 2016

(54) SYSTEM AND METHOD TO GAMIFY INSURED PROPERTY SAVINGS OPPORTUNITIES

(71) Applicant: United Services Automobile Association, San Antonio, TX (US)

(72) Inventors: Ramsey Devereaux, San Antonio, TX (US); Christina N. Nickel, Boerne, TX (US); Elizabeth J. Rubin, San Antonio, TX (US); Daniela Wheeler, Boerne, TX (US); Justin D. Haslam, San Antonio, TX (US); Thuy Hugos, San Antonio, TX (US); Spencer Read, Helotes, TX (US); Ann C. Tarrillion, San Antonio, TX (US); Allen Lay, Helotes, TX (US)

(21) Appl. No.: 14/669,112

(22) Filed: Mar. 26, 2015

(51) Int. Cl. G06Q 30/02; A63F 13/60

(52) U.S. Cl. CPC G06Q 30/0209; A63F 13/60

(57) ABSTRACT

Techniques for gamifying dwelling energy consumption include segmenting a dwelling into a plurality of zones in a gameplay scenario, determining energy consumption associated with each zone for a prescribed period of time, comparing the determined energy consumption of at least two zones with one another, and determining an optimal zone contingent upon the comparison of the at least two zones in the gameplay scenario.

### FIELD OF THE INVENTION

The present disclosure relates to insurance services, and more particularly, to visualizing and gamifying insured property savings opportunities.

### BACKGROUND OF THE INVENTION

Today, various types of risk management services (e.g., insurance services and the like) use a variety of platforms to reach an ever-increasing customer base. In particular, risk management services leverage the power and reach of networks such as the Internet and provide an environment to advertise, solicit, send information regarding various services, and otherwise provide access to manage risk management services for respective policy holders.

However, in leveraging the power and reach of networks, the environments created are often poorly designed, overly complex, and generally cumbersome to a user. For example, in certain instances, the environments are modeled to mimic traditional in-person brick and mortar experiences. Moreover, the next generation (and even some of the current generation) of prospective policy holders typically use the Internet (e.g., to communicate using social media, for entertainment such as applications, video games, etc., and the like) in significantly a different manner than traditional in-person communication (e.g., conventional brick and mortar establishments). Accordingly, modeling environments after traditional brick and mortar experiences often fails to relate or otherwise engage various policy holders.

Although attempts have been made to date to simplify the experience for existing and prospective policy holders, a need still remains for techniques that dynamically engage both existing policy holders and perspective policy holders and also balance relatable interfaces and visualizations.

### SUMMARY OF THE INVENTION

The present disclosure provides dynamically engaging environments and relatable interfaces and visualizations for property savings opportunities to perspective and existing policy holders. Such techniques particularly visualize and gamify dwelling energy consumption.

In one embodiment of the subject disclosure, a gamification platform includes techniques for gamifying dwelling energy consumption. In particular, a gamification platform (e.g., an energy consumption game running on a server node(s) in a distributed processing system) segments a dwelling into a plurality of energy consumption zones. Energy consumption associated with each zone for a prescribed period of time is determined. The determined energy consumption of at least two energy consumption zones is compared with one another. An optimal zone is determined based on the comparison of these energy consumption zones in a gameplay scenario.

### BRIEF DESCRIPTION OF THE DRAWINGS

So that those skilled in the art to which the subject invention appertains will readily understand how to make and use the devices and methods of the subject invention without undue experimentation, preferred embodiments thereof will be described in detail herein below with reference to certain figures, wherein:

FIG. 1 illustrates an example communication network in accordance with an illustrated embodiment;

FIG. 2 illustrates a network computer device/node in accordance with an illustrated embodiment;

FIG. 3A is a block diagram of an insured property from which sensor data is captured for subsequent analysis in accordance with an illustrated embodiment;

FIG. 3B is a block diagram illustrating appliances from which sensor data is captured for subsequent analysis in accordance with an illustrated embodiment;

FIG. 4 is a flow diagram of operational steps of the gamifying energy consumption program of FIGS. 3A and 3B in accordance with an illustrated embodiment;

FIG. 5 is a flow diagram of operational steps of the energy consumption analyzer program of FIG. 3 in accordance with an illustrated embodiment;

FIG. 6 is a flow diagram of operational steps of the gamifying energy consumption program of FIG. 3 in accordance with another illustrated embodiment;

FIG. 7 is a flow diagram of operational steps of the gamifying energy consumption program of FIG. 3 in accordance with yet another illustrated embodiment.

A component or a feature that is common to more than one drawing is indicated with the same reference number in each of the drawings.

### DETAILED DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

As used herein, the term “insurance” refers to a contract between an insurer, also known as an insurance company, and an insured, also known as a policyholder, in which the insurer agrees to indemnify the insured for specified losses, costs, or damage on specified terms and conditions in exchange of a certain premium amount paid by the insured. In a typical situation, when the insured suffers some loss for which he/she may have insurance the insured makes an insurance claim to request payment for the loss. It is to be appreciated for the purpose of the embodiments illustrated herein, the insurance policy is not to be understood to be limited to a residential or homeowners insurance policy, but can be for a commercial, umbrella, and other insurance policies known by those skilled in the art.

As used herein, “loss related data” means data or information relating to a loss or potential loss to insured property.

As used herein, “insured property” means a dwelling, other buildings or structures, personal property, or business property that may be covered by an insurance policy.

As used herein, the term “user” refers to people who play the games or use the gamified applications. The terms “user” and “player” are interchangeable.

Also, as used herein, the term “gamification” not only refers to the idea of infusing game design techniques and game mechanics into non-game applications, but also refers to applications that are gamified. The term “gamification” and the term “game” are interchangeable in this disclosure.

As discussed above, the subject disclosure provides a gamification environment that gamifies dwelling energy consumption for current and prospective policy holders. As used herein, gamification also refers to a design approach that applies or visualizes game mechanics to otherwise non-game scenarios. For example, certain reward cards or tokens of loyalty at coffee shops, by which you fill the card and/or earn rewards to receive a free cup of coffee represents one design approach to gamification.

With respect to insurance services, the subject disclosure provides a gamification platform using one or more servers (e.g., a distributed processing system) to better visualize energy consumption behavior of a user as well as visualize cost saving opportunities (either currently secured by the user or future potential policies).

For purposes of discussion herein, in various embodiments of the present invention gamification techniques may be incorporated that reward users or players for accomplishing or engaging in certain activities. Gamification encourages competition among the users and uses that competition to cause the users to accomplish the desired activities (i.e., saving energy) while feeling like they are playing games.

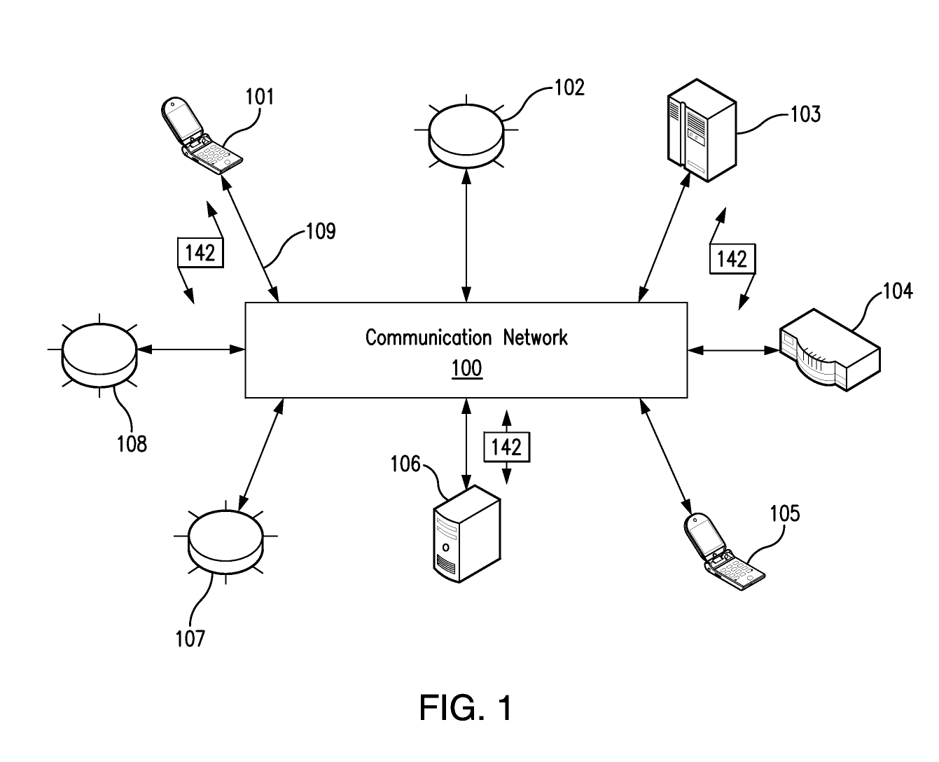

Turning now descriptively to the drawings, in which similar reference characters denote similar elements throughout the several views, FIG. 1 depicts an exemplary communications network 100 in which below illustrated embodiments may be implemented.

It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as an insured property 300 or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example communication network 100 illustratively comprising nodes/devices 101-108 (e.g., sensors 102, client computing devices 103, smart phone devices 105, servers 106, routers 107, switches 108 and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C++” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

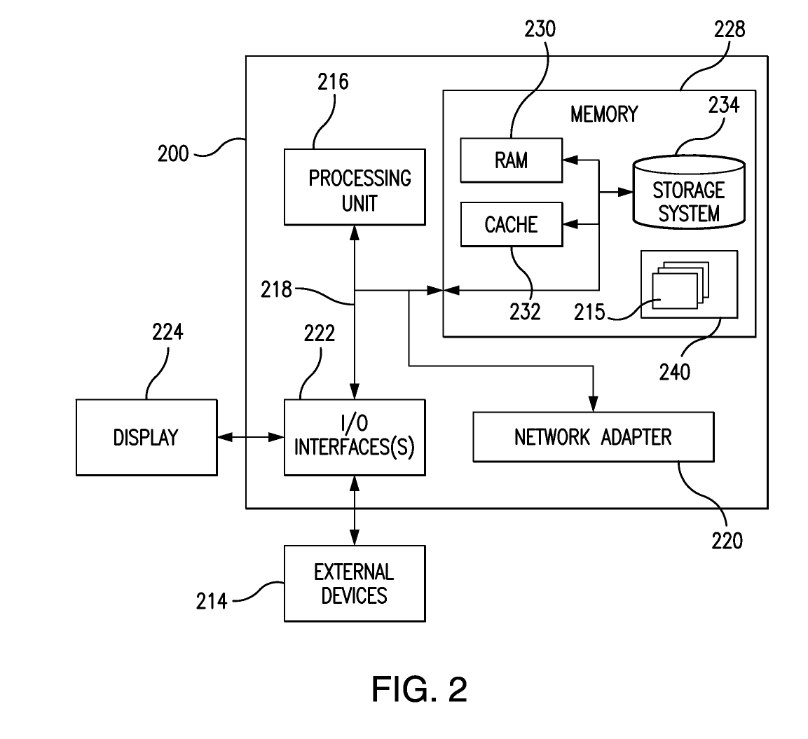

FIG. 2 is a schematic block diagram of an example network computing device 200 (e.g., insurance server 106) that may be used (or components thereof) with one or more embodiments described herein, e.g., as one of the nodes shown in the network 100.

Device 200 is only one example of a suitable gamification system and is not intended to suggest any limitation as to the scope of use or functionality of embodiments of the invention described herein. Regardless, computing device 200 is capable of being implemented and/or performing any of the functionality set forth herein.

Computing device 200 is operational with numerous other general purpose or special purpose computing system environments or configurations. Examples of well-known computing systems, environments, and/or configurations that may be suitable for use with computing device 200 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed data processing environments that include any of the above systems or devices, and the like.

Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network. In a distributed data processing environment, program modules may be located in both local and remote computer system storage media including memory storage devices.

Device 200 is shown in FIG. 2 in the form of a general-purpose computing device. The components of device 200 may include, but are not limited to, one or more processors or processing units 216, a system memory 228, and a bus 218 that couples various system components including system memory 228 to processor 216. It is to be appreciated device 200 may be located within a dwelling for which the below described process is applicable to, or alternatively the device 200 may be located at a third party which collects such data from a plurality of dwellings.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of the invention.

Program/utility 240, having a set (at least one) of program modules 215, such as resource consumption analyzer program 306 and gamifying resource consumption program 308 described below, may be stored in memory 228 by way of example, and not limitation, as well as an operating system, one or more application programs, other program modules, and program data. For ease of description and illustration the resource consumption analyzer program 306 and gamifying resource consumption program 308 are described below in terms of an energy consumption analyzer program 306 and gamifying energy consumption program 308 since a below illustrated embodiment is described relative to determination of energy consumption, but it is not to be understood to be limited to only determination of energy consumption as it encompasses determination of consumption of other resources such as gas and water.

Each of the operating system, one or more application programs, other program modules, and program data or some combination thereof, may include an implementation of a networking environment. Program modules 215 generally carry out the functions and/or methodologies of embodiments of the invention as described herein.

Device 200 may also communicate with one or more external devices 214 such as a keyboard, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: microcode, device drivers, redundant processing units, external disk drive arrays, RAID systems, tape drives, and data archival storage systems, etc.

FIGS. 1 and 2 are intended to provide a brief, general description of an illustrative and/or suitable exemplary game framework environment in which embodiments of the below described present invention may be implemented. FIGS. 1 and 2 are exemplary of a suitable environment and are not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

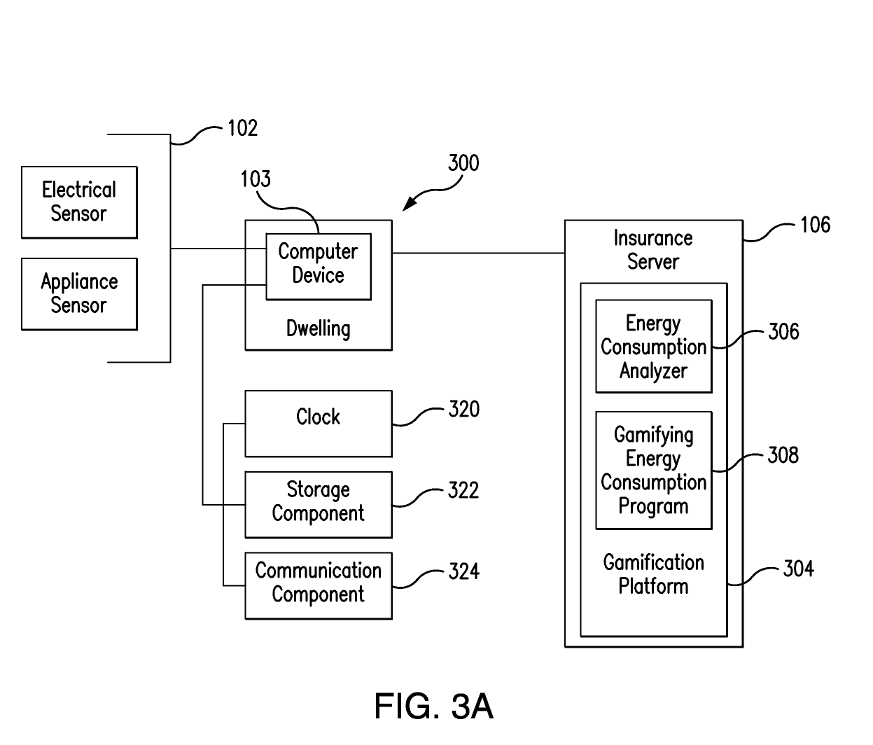

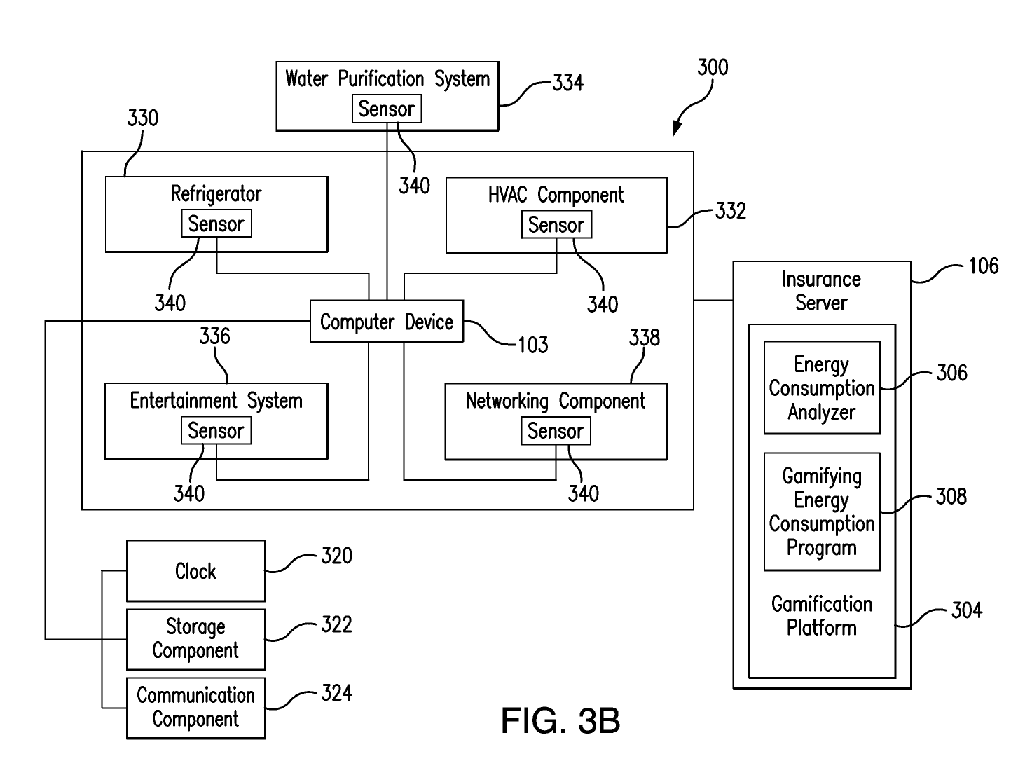

With the exemplary communication network 100 (FIG. 1) and computing device 200 (FIG. 2) being generally shown and discussed above, description of certain illustrated embodiments of the present invention will now be provided. With reference now to FIG. 3, an example of an insured property 300 is shown which is to be understood to be any type of structure (e.g., residential, commercial, retail, municipal, etc.) in which the capture and analysis of sensor data (102) is useful for the reasons at least described below. Insured property 300 preferably includes a computing device 103 for capturing data from a plurality of sensors 102 which capture data regarding various energy consumption related aspects of insured property 300, as further described below. It is to be understood insured property computing device 103 may be located in any location, and its position is not limited to the example shown.

Computing device 103 is preferably configured and operational to receive (capture) data from various sensors 102 and transmit that captured data to a remote server 106, via network 100. It is noted device 103 may perform analysis of the captured sensor data directed to various energy consumption related aspects of insured property 300 and/or the remote server 106, preferably located or controlled by an insurance company/carrier, may perform such analysis, as also further described below. It is also to be understood in other embodiments, data from sensors 102 may be transmitted directly to remote server 106, via network 100, thus either obviating the need for computing device 103 or mitigating its functionality to capture all data from sensors 102.

In the illustrated embodiment of FIG. 3, computing device 103 is shown coupled to various below described sensor types 102. Although various sensor types 102 are described below and shown in FIG. 3, the sensor types described and shown herein are not intended to be exhaustive as embodiments of the present invention may encompass any type of known or unknown sensor type which facilitates the purposes and objectives of the certain illustrated embodiments described herein.

Electrical System Sensor—

Electrical system sensor 102 detects the operational parameters of the structure's electrical system. Readings from sensor 102 could be used to determine if the voltage is (persistently) too high, too low, or if the voltage frequently drops and/or spikes. Such conditions may suggest that the structure 300 is at risk for fire. Other types of electrical measurements could be taken, such as readings of current flowing through the electrical system. Still other types of electrical measurements could be determined include how energy is used and at what times of day it is used, etc.

Appliance Sensor—

Appliance sensor 102 detects various operating parameters relating to appliances within an insured property 300. Examples of appliances include (but are not limited to) all kitchen appliances (e.g., refrigerator, freezer, stove, cooktop, oven, grill, dishwasher, etc.); HVAC components (air conditioner, heating system, air handlers, humidifiers/de-humidifiers, etc.), water purification system, media entertainment system (e.g., televisions), networking components (routers, switches, extenders, etc.) electrical generator system, pool filtration and heating system, sump pump and water well system, septic tank system, garage door opener, etc. An appliance sensor may comprise detection hardware, or may employ one or more remote probes, which may be located inside and/or outside the insured property 300 functional to detect certain operating parameters of appliances. Operating parameters detected by an appliance sensor 102 may include (but are not limited to): the operating efficiency of an appliance (energy usage, output performance); the time an appliance operates, the age of an appliance.

It is to be understood and appreciated the aforementioned sensors 102 may be configured as wired and wireless types integrated in a networked environment (e.g., WAN, LAN, WiFi, 802.11X, 3G, LTE, etc.), which may also have an associated IP address. It is to be further appreciated the sensors 102 may consist of internal sensors located within the structure of insured property 300 or external sensors located external of the structure of insured property 300. It is additionally to be understood and appreciated that sensors 102 can be networked into a central computer hub (e.g., device 103) in an insured property to aggregate collected sensor data packets. Aggregated data packets can be analyzed in either a computer system (e.g., device 103) or via an external computer environment (e.g., server 106). Additionally, it is to be understood data packets collected from sensors 102 can be aggregated in computing device 103 and sent as an aggregated packet to server 106 for subsequent analysis whereby data packets may be transmitted at prescribed time intervals (e.g., a benefit is to reduce cellular charges in that some insured property's 300 may not have Internet access or cellular service is backup when Internet service is nonfunctioning).

In accordance with an illustrated embodiment, in addition to the aforementioned, the sensors 102 being utilized relative to insured property 300, computing device 103 may additionally be coupled to a Clock 320 which may keep track of time for device 103, thereby allowing a given item of data to be associated with the time at which the data was captured. For example, device 103 may recurrently capture readings of temperature, appliance operating times, etc., and may timestamp each reading. The time at which the readings are taken may be used to reconstruct events or for other analytic purposes, such as those described below.

A storage component 322 may further be provided and utilized to store data readings and/or timestamps in device 103. For example, storage component 322 may comprise, or may otherwise make use of, magnetic or optical disks, volatile random-access memory, non-volatile random-access memory, or any other type of storage device. There may be sufficient data storage capacity to store several hours or several days worth of readings. Storage component 322 might have sufficient storage capacity to allow, for example fourteen days of readings to be stored, thereby allowing narrowing down the cause of atypical energy use, for example.

A communication component 324 may further be provided and utilized to communicate recorded information from computing device 103 to an external location, such as computer server 106, which may be associated with an insurance carrier such as USAA. Communication component 324 may be, or may comprise, a network communication card such as an Ethernet card, a WiFi card, or any other communication mechanism. However, communication component 324 could take any form and is not limited to these examples. Communication component 324 might encrypt data that it communicates, in order to protect the security and/or privacy of the data.

Communication component 324 may communicate data recorded by device 103 (e.g., data stored in storage component 322) to an external location, such as server 106. For example, server 106 may be operated by an insurance company, and may collect data from computing device 103 in order to learn about energy consumption needs and other analytics relative to insured property 300 in which device 103 located. Communication component 324 may initiate communication sessions with server 106. As another example, server 106 may contact device 103, through communication component 324, in order to receive data that has been stored by device 103. Additionally, data from sensors 102, clock 320 and/or storage component 322 may be communicated directly to server 106, via network 100, thus obviating or mitigating the need for computing device 103.

In the example of FIG. 3A, communication component 324 (which is shown, in FIG. 3A, as being part of, or used by, computing device 103) communicates data to server 106. Server 106 may comprise, or otherwise may cooperate with, a gamification platform 304, which may facilitate gamification of dwelling energy consumption in some manner. The gamification platform 304 may include various hardware and software components capable of implementing the functions described below. In this manner, the gamification platform 304 adds game-design elements and mechanics to the other elements of the insurance server 106, without adversely impacting how the elements of the insurance server 106 perform their native, insurance-based functions. For example, games or objectives may be communicated to current or prospective policyholders, along with an incentive to achieve the objective, in an attempt to achieve a goal of saving costs associated with certain energy consumption behavior. A gamification platform 304 can add to native functions to create a customizable insurance platform that integrates game-based functionality and interfaces, including game-design elements, with an existing property carrier's insurance products and customer systems, including, for example, sales, marketing, actuarial analysis, product design, pricing, policyholder service, etc. The gamification platform 304 may also be used to design new products and services and develop a deeper understanding of customers through analytics. In addition, the gamification platform 304 may be linked to other systems, for example, social networks and other computer-based communication systems.

In one embodiment, the components of gamification platform 304 may include energy consumption analyzer component 306 and Gamifying Energy Consumption (GEC) program 308. Energy consumption analyzer 306 may comprise various types of sub-modules, such as appliance analyzer (not shown in FIG. 3A). In general, energy consumption analyzer 306 may perform an analysis of collected data regarding various aspects of energy consumption with respect to insured property 300. The appliance analyzer may perform an analysis of collected data regarding various appliances located in or around insured property 300, such as their age, operating parameters, maintenance/repair issues, and the like. In the exemplary embodiment shown in FIG. 3A, the gamification platform 304 may use a customizable GEC application/process 308 that may provide a dynamic game engine to apply game mechanics to the problem of reducing the number and severity of wasteful and/or risky energy-related behaviors and/or events, such as, for example, excessive usage of electrical appliances.

Energy consumption analyzer 306 and GEC 308 may overlap somewhat in terms of the techniques they employ—e.g., both of these sub-modules may analyze facts such as room temperature, humidity, etc., and attempt to draw some energy consumption related conclusions based on whether and/or how these facts have changed over time.

As previously noted, insured property 300 may contain a plurality of appliances located therein or in its vicinity. FIG. 3B is a block diagram illustrating such appliances from which sensor data is captured for subsequent analysis in accordance with an illustrated embodiment. Computing device 103 elements such as clock 320, storage component 322 and communication component 324, as well as sub-modules of data analysis module 304 have already been described with respect to FIG. 3A. For brevity, those elements are not further described with respect to FIG. 3B. In addition to those elements already described, illustratively, a plurality of appliances are depicted in FIG. 3B. Examples of appliances include (but are not limited to) all kitchen appliances (e.g., refrigerator 330, freezer, stove, cooktop, oven, grill, dishwasher, etc.); HVAC components 332 (air conditioner, heating system, air handlers, humidifiers/de-humidifiers, etc.), water purification system 334, media entertainment system 336 (e.g., televisions), networking components 338 (routers, switches, extenders, etc.), electrical generator system, and the like. In many of the embodiments, appliances 330-338 have a computer based architecture or a controller that enables communication of data concerning the electronic appliance. It is to be understood appliances 330-338 may be located in any location inside or outside of insured property 300, and their positions are not limited to the example depicted in FIG. 3B. In addition, a plurality of appliance sensors 340 may be attached to and/or operatively connected to controllers of appliances 330-338.

Each of the appliance sensors 340 may be configured and operational to preferably detect various operating parameters relating to appliances 330-338 within or outside the insured property 300. An appliance sensor may comprise detection hardware, or may employ one or more remote probes, which may be located inside and/or outside the insured property 300, functional to detect certain operating parameters of appliances 330-338. It is to be appreciated the present invention is operational and configured to detect appliance resource consumption of at least one or more of electrical power consumption, water consumption, gas consumption and consumption of other like resources. However, for ease of description and illustration purposes, the below described illustrative embodiment is described relative to electrical energy consumption, but embodiments of the present invention are not to be understood to be limited thereto.

Operating parameters detected by an appliance sensor 340 may include (but are not limited to): electrical power consumption, water consumption, gas consumption and consumption of other like resources, as mentioned above. The operating parameters may further include the operating efficiency of an appliance (energy usage, output performance); the time an appliance operates, the age of an appliance. Such appliance readings from one or more appliances 330-338 could thus be recorded by device 103 and used by energy consumption analyzer 308 in various ways.

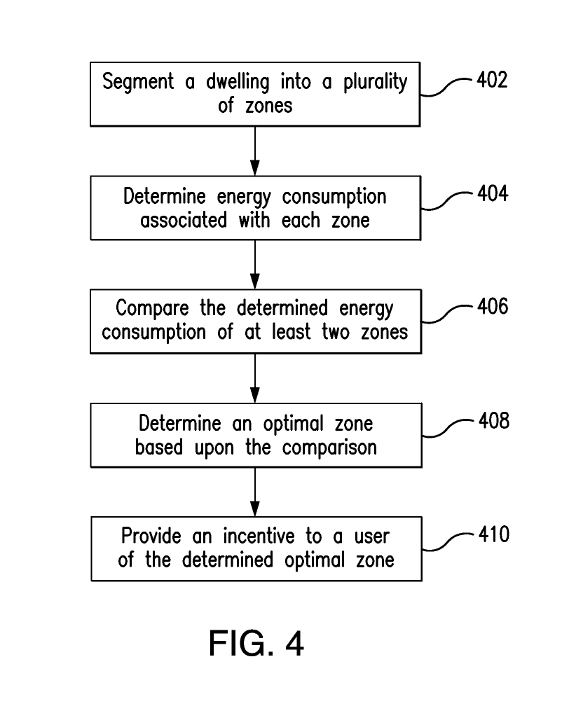

FIGS. 4-7 are flowcharts of operational steps of energy consumption analyzer component 306 and GEC component 308 of FIGS. 3A and 3B, in accordance with exemplary embodiments of the present invention. Before turning to descriptions of FIGS. 4-7, it is noted that the flow diagrams shown therein are described, by way of example, with reference to components shown in FIGS. 3A and 3B, although these operational steps may be carried out in any system and are not limited to the scenario shown in the aforementioned figures. Additionally, the flow diagrams in FIGS. 4-7 show examples in which operational steps are carried out in a particular order, as indicated by the lines connecting the blocks, but the various steps shown in these diagrams can be performed in any order, or in any combination or sub-combination. It should be appreciated that in some embodiments some of the steps described below may be combined into a single step. In some embodiments, one or more additional steps may be included.

Starting with FIG. 4, FIG. 4 is a flow diagram of operational steps of the GEC program 308 of FIGS. 3A and 3B in accordance with an illustrated embodiment. In one gameplay scenario, in response to receiving information about insured property, referred to hereinafter as dwelling 300, at step 402, GEC program 308 preferably segments the dwelling into a plurality of zones. For example, GEC program 308 may segment the dwelling 300 so that each zone corresponds to one or more rooms of dwelling 300. More specifically, a heating, ventilating, and air conditioning (HVAC) system provided for controlling climate conditions in a dwelling may include a plurality of zones. In this embodiment, a plurality of sensors 102 may include a plurality of wireless thermostats disposed throughout the HVAC zones within dwelling 300. Each thermostat is operable to control a climate condition in a corresponding HVAC zone by communicating signals through a network to computing device 103 or a master control unit in communication therewith. In this case, GEC program 308 may segment dwelling 300 based on the plurality of HVAC zones. In an alternative embodiment, each zone segmented by GEC program 308 may consist of a plurality of designated appliances associated with dwelling 300. For example, a first zone may include certain appliances that are hardwired within dwelling 300, such as light fixtures. Such appliances are typically controlled by light switches. In addition, a second zone may include “plug-in” appliances, such as lamps, which are controllable by simply controlling their power source, and may be operated or controlled by a wall outlet. Further, a third zone may include appliances which require more precise control other than simply supplying or removing power from them, and which are generally operated by infrared commands from their own remotes, such as TVs, VCRs, stereos, etc., and that are operated directly from a corresponding controller by issuing such infrared commands directly to that appliance.

At step 404, GEC program 308 determines energy consumption associated with each zone for a prescribed period of time. GEC program 308 may determine each zone's efficiency based on a set of parameters related to the zone's energy usage that are normalized for weather, occupancy, and/or other external parameters. In one embodiment, this step contemplates GEC program 308 receiving the amount of consumed electrical power from energy consumption analyzer 306. One of the most beneficial advantages of gamifying dwelling energy consumption, as provided in one embodiment of the present invention, is accurate reporting of the actual amount of power saved by each zone on an individual basis. Embodiments of the present invention monitor and calculate precisely how many kilowatts are being generated or saved per zone instead of merely providing an estimate. According to an alternative embodiment, step 404 may include determining monetary costs associated with the energy consumption of a particular zone. In yet another embodiment, at step 404, GEC program 308 may determine the thermal performance of the zone (i.e., part of a dwelling structure).

At step 406, GEC program 308 compares the determined energy consumption of at least two zones with one another. In one embodiment, this step may include utilization of prescribed criteria for each zone being compared. For example, GEC program 308 may employ various factors to improve energy efficiency such as utility costs, public concern for the environment and human health, government regulations, and other market forces. In addition, GEC program 308 may compare each zone's determined energy consumption values to one or more baseline values. For instance, GEC program 308 may determine each zone's efficiency based on a set of prescribed efficiency metrics.

At step 408, GEC program 308 determines an optimal zone based on the comparison performed at step 406. For example, an optimal zone may comprise the most energy efficient zone. In another embodiment, an optimal zone may comprise a zone having a greatest reduction of energy consumption based on historical values. Alternatively, an optimal zone may comprise a zone having greatest cost savings associated with its energy consumption. In other words, at steps 404-408, GEC program 308 compares energy usage and monetary savings for each identified zone in one or more game play scenarios to identify an optimal (e.g., most efficient) zone. In one embodiment, results of the game may be transmitted by GEC program 308 to one or more social networks.

At step 410, GEC program 308 provides an incentive to one or more players associated with the determined optimal zone. In various embodiments such incentives for achieving or completing the objective, i.e., reducing energy consumption, may include, for example, but not limited to, virtual rewards, discounts, and/or reduced insurance rates or premiums. In some embodiments, insurance premiums, deductibles, surcharges, discounts, and/or rewards may be based on whether or not a player accesses and/or utilizes energy consumption information associated with a particular zone (i.e., optimal zone).

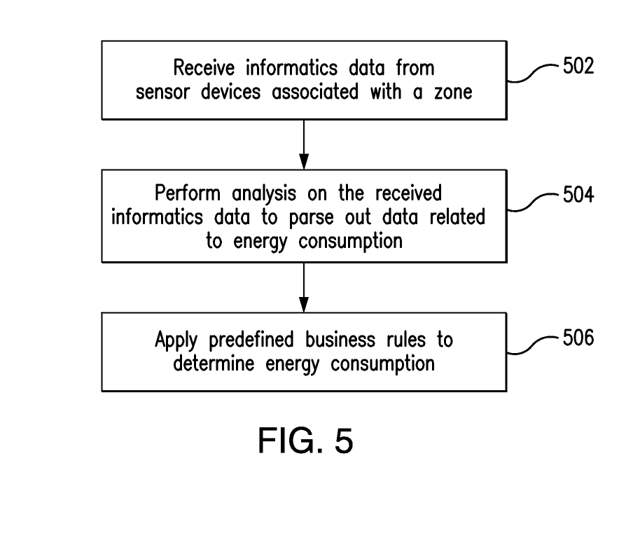

FIG. 5 is a flow diagram of operational steps of the energy consumption analyzer program of FIGS. 3A and 3B in accordance with an illustrated embodiment. With reference to FIG. 5, at 502, energy consumption analyzer 306 preferably collects data from sensors 102. In an embodiment of the present invention, this step may involve computing device 103 periodically contacting (via network 100), at prescribed time intervals, energy consumption analyzer component 306 running on server 106 to send accumulated data. In an alternative embodiment, contact between the computing device 103 and energy consumption analyzer 306 may be initiated when the energy consumption analyzer 306 contacts the computing device 103. Following the initial contact, energy consumption analyzer 306 may receive data from computing device 103. It is to be understood data packets collected from sensors 102 can be aggregated in computing device 103 and sent as an aggregated packet to energy consumption analyzer 306 for subsequent analysis.

It should be appreciated that energy consumption analyzer 306 may store the captured informatics data in a data repository (which may be a part of, or used by, insurance server 106). The data repository may comprise a database or any other suitable storage component. For example, the suitable storage component may comprise, or may otherwise make use of, magnetic or optical disks, volatile random-access memory, non-volatile random-access memory or any other type of storage device.

At step 504, in an embodiment of the present invention, energy consumption analyzer 306 optionally selectively filters aggregated data. For example, energy consumption analyzer 306 may include a parser configured to parse the aggregated packet and classify the received data based on, for example, type of sensor employed to collect a particular subset of the received data. Energy consumption analyzer 306 may create a data structure for each classification. This step may further involve identifying a zone from which the received data is collected. The main idea behind this aspect of the present invention is that energy consumption analyzer 306 may selectively parse out any data non-relevant to energy consumption calculations.

At 506, energy consumption analyzer 306 applies predefined business rules to the parsed out data to determine energy consumption of the identified dwelling zone. In one embodiment these business rules may provide in-depth energy consumption analysis whenever necessary. More particularly, energy consumption analyzer 306 may be configured to determine energy consumption based on a plurality of factors, such as, but not limited to, historical energy usage and appliance performance data, appliance manufacturer specifications, market rules, utility rates, weather data, and the like. As noted above, energy consumption analyzer 306 preferably transmits results of the analysis performed at step 506 to GEC program 308.

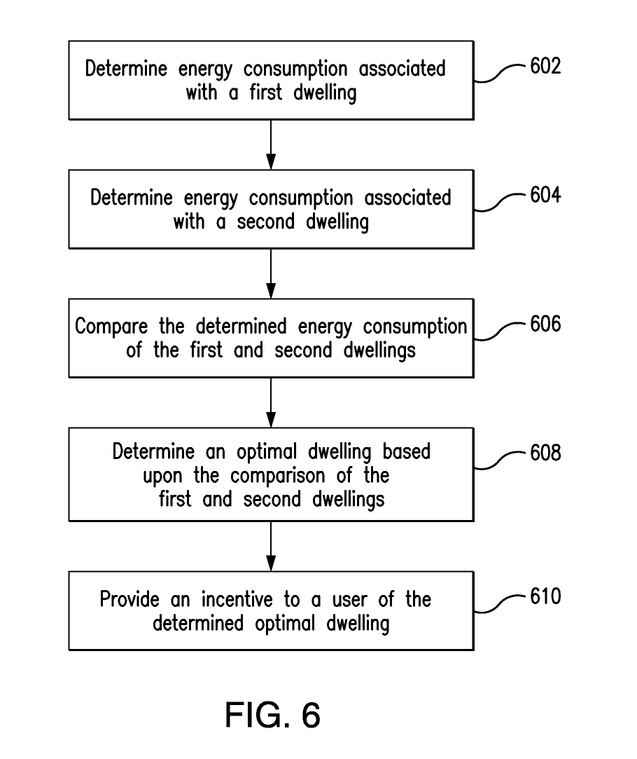

FIG. 6 is a flow diagram of operational steps of the gamifying energy consumption program of FIGS. 3A and 3B in accordance with another illustrated embodiment. Steps 602-610 are substantially identical to operational steps 402-410 of GEC program 308 described above, such that these steps will not be described in detail again for the sake of brevity. The only difference is that the analysis of energy consumption is performed for at least two different dwellings rather than at least two different zones of the same dwelling resulting in a determination of an optimal dwelling rather than an optimal zone. Furthermore, according to the disclosed embodiment, one or more users of a first dwelling may compete against users of other dwellings. In an exemplary gameplay scenario, users of different dwellings can challenge each other to competitions based on real-time energy consumption events (i.e., intra-dwelling competition). Each user can then experience the competition through a user interface on a computing device associated with that user. For example, the competition may be presented to each user by GEC program 308 as an energy consumption game, with the gameplay experience and the outcome of the game (i.e., optimal dwelling having a greatest reduction of energy consumption) being determined by the analysis described above.

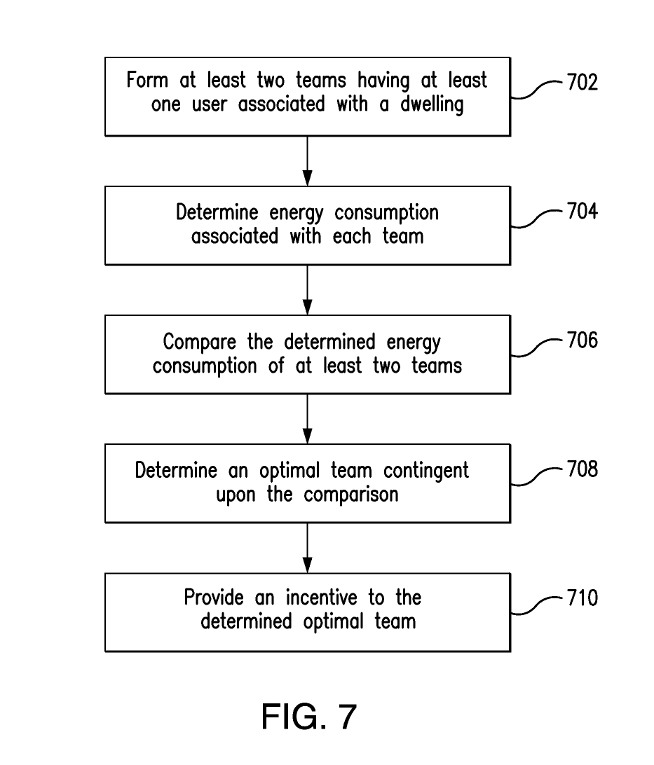

FIG. 7 is a flow diagram of operational steps of the gamifying energy consumption program of FIGS. 3A and 3B in accordance with yet another illustrated embodiment. Steps 702-710 are substantially identical to operational steps 402-410 of GEC program 308 described above, such that these steps will not be described in detail again for the sake of brevity. The only difference is that the analysis of energy consumption is performed for at least two different teams rather than at least two different zones of a dwelling resulting in a determination of an optimal team rather than an optimal zone. Furthermore, according to the disclosed embodiment, at step 702 a team of users may be formed for gameplay. In various embodiments teams may be formed based on various grouping criteria, such as, friends and/or family groupings, neighborhood groupings, regional groupings (city, state, country, etc.), social network groupings, and the like. For instance, in other exemplary gameplay scenarios, GEC program 308 is configured and operation to create user groupings, wherein groupings may challenge one another. For instance, a grouping can consist of user's residing in a certain neighborhood (e.g., defined by a geo-fence) such that a neighborhood may challenge another neighborhood. Yet another example includes a grouping according to a type of military service a user is associated with such that a gameplay scenario may include army v. navy.

In an exemplary gameplay scenario, the first group member to log into a game that supports teams can form a team representing the group. Other group members can then join in the game as a member of the team. Thus, at step 702, GEC program 308 manages the formation of a team. For example, GEC program 308 may assign the team an identifier and may maintain it for the group. In one embodiment, players can be invited to join a group at any time by a player that is already a member of the group. Any invited player can join a group. Team members can be assigned roles, such as captain of the team, for example. In an exemplary embodiment, the game title manages attributes of a team such as the roles of members of a team, the minimum and/or maximum number of team members, the minimum and/or maximum number of team members that can participate in a game session, for example. GEC program 308 may maintain team attributes, team achievements, and team statistics with respect to energy consumption. As previously noted the outcome of the game (i.e., optimal team having a greatest reduction of energy consumption) is determined based on the analysis of energy consumption associated with each team as described above with respect to FIGS. 4 and 6.

In yet another alternative embodiment, the system of the present invention is configured and operational for disaggregation of collected sensor resource consumption data such that disaggregated electrical use, water use and gas use enables determination of how a homeowner is consuming resources in their home. For instance, disagregation of the data will allow an insurance carrier and/or the water/power/gas provider to know what appliances, sinks, showers, etc the homeowner is using. The insurance carrier and/or the water/power/gas provider could use this specific information on how the electricity/water/gas is being generated and help the homeowner, through a gamified processes, reduce their risk of damage. The disaggregated data could also identify high energy users and through a gamified process help the homeowner reduce consumption.

The techniques described herein, therefore, provide an interactive, dynamic and engaging gamification platform that gamifies dwelling energy consumption. In particular, the gaming techniques described above provide advice, protection, and financial planning (e.g., cost saving opportunities) that are customizable for each individual user. In particular, the techniques herein provide entertaining and relatable techniques that educate users regarding negative energy consumption behavior and potential impact such scenarios can have on the user's financial status as well as account for any secured or prospective insurance policies.

The foregoing description has been directed to specific embodiments. It will be apparent, however, that other variations and modifications may be made to the described embodiments, with the attainment of some or all of their advantages. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method for gamifying dwelling energy consumption, the method comprising:
segmenting, by a processor, a dwelling into a plurality of zones;
determining, by the processor, resource consumption associated with each zone for a prescribed period of time;
comparing, by the processor, the determined resource consumption of at least two said zones with one another; and
determining, by the processor, an optimal zone contingent upon said comparison of said at least two zones in a gameplay scenario.

2. The method as recited in claim 1, wherein a said zone corresponds to one or more rooms of a dwelling.

3. The method as recited in claim 1, wherein a said zone consists of designated appliances associated with the dwelling.

4. The method as recited in claim 1, wherein said determined resource consumption consists of at least one of consumed electrical power, water and gas.

5. The method as recited in claim 1, wherein said determined resource consumption consists of monetary cost associated with resource consumption of a said zone.

6. The method as recited in claim 1, wherein said comparing at least two zones includes utilization of prescribed criteria for each said zone being compared to other said zones.

7. The method as recited in claim 1, wherein said determining an optimal zone consists of identifying a zone having a greatest reduction of resource consumption.

8. The method as recited in claim 1, wherein said determining an optimal zone consists of identifying a zone having a greatest cost savings associated with its resource consumption.

9. The method as recited in claim 1, further including providing the gameplay scenario via social media.

10. The method as recited in claim 1, wherein determining resource consumption for a zone includes:
receiving informatic data from one or more sensor devices associated with a zone;
performing analysis on the received informatic data to identify and parse out data relating to resource consumption of said zone; and
applying predefined business rules to the parsed out data to determine resource consumption of said zone.

11. The method as recited in claim 1, further including providing an incentive to a user of the determined optimal zone.

12. A method for gamifying dwelling resource consumption, the method comprising:
determining, by a processor, resource consumption associated with a first dwelling for a prescribed period of time;
determining, by a processor, energy consumption associated with at least one other second dwelling for the prescribed period of time;
comparing, by a processor, the determined resource consumption of the first and second dwellings; and
determining, by the processor, an optimal dwelling based upon said comparison of said first and second dwellings in a gameplay scenario.

13. The method as recited in claim 12, wherein said determined resource consumption consists of at least one of consumed electrical power, water and gas.

14. The method as recited in claim 12, wherein said determined resource consumption consist of monetary cost associated with resource consumption of a said zone.

15. The method as recited in claim 12, wherein said gameplay scenario includes a user of a said first dwelling challenging a user of a said second dwelling.

16. The method as recited in claim 12, wherein said determining an optimal dwelling consists of identifying a dwelling having a greatest reduction of resource consumption.

17. The method as recited in claim 12, further including providing an incentive to a user of the determined optimal dwelling.

18. A method for gamifying dwelling resource consumption, the method comprising:
forming, by a processor, at least two teams wherein each team has at least one user associated with a dwelling;
determining, by the processor, resource consumption associated with each team for a prescribed period of time;
comparing, by the processor, the determined resource consumption of at least two teams with one another; and
determining, by the processor, an optimal team contingent upon said comparison of said at least two teams in a gameplay scenario.

19. The method as recited in claim 18, wherein each team is user selected via a gameplay scenario.

20. The method as recited in claim 18, further including providing an incentive to the determined optimal team.
